(19) United States
(12) Patent Application Publication
(10) Pub. No.: US 2015/0379075 A1
(43) Pub. Date: Dec. 31, 2015

(54) MAINTAINING DIVERSITY IN MULTIPLE OBJECTIVE FUNCTION SOLUTION OPTIMIZATION

(71) Applicant: International Business Machines Corporation, Armonk, NY (US)

(72) Inventors: Satoshi Hara, Tokyo (JP); Tetsuro Morimura, Tokyo (JP); Hidemasa Muta, Hachioji (JP); Raymond H.P. Rudy, Yokohama (JP)

(21) Appl. No.: 14/729,517

(22) Filed: Jun. 3, 2015

(30) Foreign Application Priority Data
Jun. 30, 2014 (JP) 2014-134426

(51) Int. Cl. G06F 17/30

(52) U.S. Cl. CPC G06F 17/30442

(57) ABSTRACT

A computer performs searching in order to optimize a plurality of input parameters. Each of the input parameters is input to a time-series trial process. The computer receives a plurality of input parameters and performs a trial process on each of the plurality of input parameters. The computer then calculates an evaluation value of the trial process performed on each of the plurality of input parameters and calculates a degree of similarity among a plurality of trial processes based on a feature value. Each of the feature values is extracted from the trial process performed on a corresponding one of the plurality of input parameters. The computer updates the plurality of input parameters based on the evaluation value of the trial process calculated for each of the plurality of input parameters and the degree of similarity among the plurality of trial processes.

### BACKGROUND

The present invention relates to an information processing and more particularly to optimizing multiple objective function solutions.

As a method for searching for an approximate solution, a genetic algorithm employing an evolution model of creatures is known (for example, as taught in publication “Genetic Algorithms in Search, Optimization, & Machine Learning” by David E. Goldberg). When the genetic algorithm is used to solve a problem of maximizing (or minimizing) the values of multiple objective functions which conflict with each other, the values of the multiple objective functions fail to be simultaneously improved, and a group of solutions having a trade-off relationship between each other forms a Pareto front surface.

However, in a genetic algorithm of the related art, when evaluation values which are results of evaluation of solutions, made by obtaining, for example, an arithmetic mean of the values of the multiple objective functions, are used to evolve a group of solutions, the finally obtained group of solutions concentrates at one point, often resulting in loss of diversity of the solutions.

The following known methods address this problem: a method in which solutions are ranked in the order from closest to the Pareto front surface and in which a crossover operator is performed on the solutions with priority according to the rank (as taught by C. M. Fonseca and P. J. Fleming in “Multiobjective Genetic Algorithms”); and a method in which solutions are grouped into multiple groups, each of which includes solutions which are located close to each other in an objective functions space, and in which a solution having the highest evaluation is made to survive in each group while the other solutions are selected (as taught by J. Horn, N. Nafpliotis and D. E. Goldberg: “A Niched Pareto Genetic Algorithm for Multiobjective Optimization”).

Alternatively to a genetic algorithm, a metaheuristic algorithm using multiple objective functions, such as simulated annealing, particle swarm optimization, or tabu search, can be used to solve a problem of searching for an optimized model to which multiple input parameters are input and from which multiple output parameters are output.

Publication “A Niched Pareto Genetic Algorithm for Multiobjective Optimization” by J. Horn, N. Nafpliotis and D. E. Goldberg disclose a method to search for an optimized initial condition of a simulation in which solutions are grouped only by using objective function values obtained upon completion of the simulation, causing the simulation processes not to be completely considered. For example, in the method, even when different phenomena occur in the simulation processes, solutions whose final objective function values are located close to each other by coincidence may be grouped into one group. Such an incorrect grouping causes diversity of solutions not to be sufficiently guaranteed.

Therefore, an object of the present invention is to search for optimal solutions efficiently while ensuring the diversity of the optimal solutions, in the case where a metaheuristic algorithm, such as a genetic algorithm, simulated annealing, particle swarm optimization, or tabu search, is applied to searching with evaluation using a time-series trial process such as a simulation.

### SUMMARY

Embodiments of the present invention disclose a method, computer program product, and system which performs searching in order to optimize a plurality of input parameters, each of which is input to a time-series trial process. A computer receives a plurality of input parameters and performs a trial process on each of the plurality of input parameters. The computer then calculates an evaluation value of the trial process performed on each of the plurality of input parameters and calculates a degree of similarity among a plurality of trial processes based on a feature value extracted from the trial process performed on a corresponding one of the plurality of input parameters. The computer updates the plurality of input parameters based on the evaluation value calculated for each of the plurality of input parameters and the degree of similarity among the plurality of trial processes.

The above-described summary of the present invention is not one listing all of the necessary features of the present invention. Any combination of one or more of these features constitutes an invention.

### BRIEF DESCRIPTION OF THE SEVERAL VIEWS OF THE DRAWINGS

Features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a block diagram illustrating an information processing system, in accordance with an embodiment of the present invention;

FIG. 2 illustrates a process flow performed by the information processing system of FIG. 1, in accordance with an embodiment of the present invention;

FIG. 3 illustrates an exemplary input parameter to be processed by the information processing system, in accordance with an embodiment of the present invention;

FIG. 4 illustrates an exemplary degree of similarity calculated by a similarity calculating module, in accordance with an embodiment of the present invention;

FIG. 5 illustrates exemplary evaluation values calculated by an evaluation calculating module, in accordance with an embodiment of the present invention;

FIG. 6 illustrates the relationship between multiple genes and corresponding objective function values, in accordance with an embodiment of the present invention;

FIG. 7 illustrates exemplary groupings of individuals by a parameter update module, in accordance with an embodiment of the present invention;

FIG. 8 illustrates exemplary selection of individuals by the parameter update module, in accordance with an embodiment of the present invention;

FIG. 9 illustrates exemplary creation of new individuals by the parameter update module, in accordance with an embodiment of the present invention;

FIG. 10 illustrates an exemplary trial process of the information processing system, in accordance with an embodiment of the present invention;

FIG. 11 illustrates exemplary process results of the information processing system and comparison results, in accordance with an embodiment of the present invention; and

FIG. 12 illustrates an exemplary hardware configuration of a computer.

### DETAILED DESCRIPTION

The present invention will be described below through an embodiment, but the embodiment described below does not limit the invention defined in the scope of claims. In addition, all of the combinations of features described in the embodiment are not necessarily required for the solution of the invention.

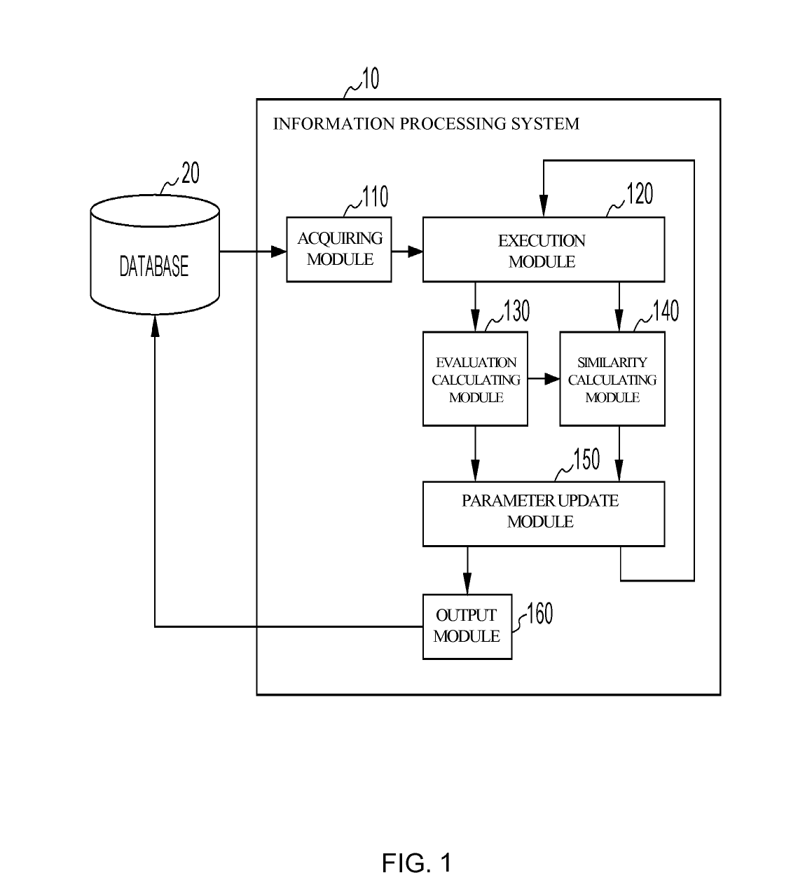

FIG. 1 is a block diagram illustrating an information processing system 10, in accordance with an embodiment of the present invention. The information processing system 10 can optimize input parameters, each of which is input to a time-series trial process, such as an agent-based simulation for multiple objective functions by using, for example a genetic algorithm. The information processing system 10 can search for a group of optimal solutions of the input parameters while maintaining solution diversity. The information processing system 10 can include an acquiring module 110, an execution module 120, an evaluation calculating module 130, a similarity calculating module 140, a parameter update module 150, and an output module 160.

The acquiring module 110 acquires multiple input parameters, each of which is to be input to a time-series trial process, from a database 20. For example, the acquiring module 110 can acquire multiple parameters, each of which is defined as a gene of an individual in terms of the genetic algorithm, as input parameters. The acquiring module 110 can supply the acquired input parameters to the execution module 120.

The execution module 120 can execute a time-series trial process including multiple time points for each of the input parameters. For example, the execution module 120 can execute an agent-based simulation as the time-series trial process. The execution module 120 can supply information about the execution state of the time-series trial process to the evaluation calculating module 130 and to the similarity calculating module 140.

The evaluation calculating module 130 can calculate evaluation values of a trial process performed by the execution module 120 on each of the input parameters. The evaluation calculating module 130 can calculate an evaluation value by using objective functions for converting the execution state at a time point of the trial process into a number. For example, for each of the input parameters, the evaluation calculating module 130 can calculate objective function values for the execution state at each of the time points of the trial process, and can calculate an evaluation value on the basis of the calculated objective function values. The evaluation calculating module 130 can supply the calculated evaluation values to the similarity calculating module 140 and the parameter update module 150.

The similarity calculating module 140 can calculate degrees of similarity among multiple trial processes on the basis of feature values extracted from the trial processes, each of which is performed on a corresponding one of the input parameters. For example, the similarity calculating module 140 can extract, as feature values, evaluation values or objective function values at one or more time points in the course of the period of the time-series trial process for each of the input parameters, and can calculate degrees of similarity among the trial processes on the basis of closeness of the feature values of the trial processes. The similarity calculating module 140 can supply the calculated degrees of similarity to the parameter update module 150.

The parameter update module 150 can update the input parameters on the basis of the evaluation values of the input parameters and the degrees of similarity among the trial processes. For example, the parameter update module 150 can create new genes by performing crossover, mutation, and selection operators on the group of individuals each having a gene corresponding to a trial process, on the basis of the genetic algorithm.

For example, the parameter update module 150 can select individuals having a gene with a low evaluation value among multiple genes which satisfy a similarity relationship, on the basis of the evaluation values of the trial processes corresponding to the respective input parameters and the degrees of similarity among the trial processes, and can create new genes through a crossover operator performed on two or more genes which are not selected. The parameter update module 150 can supply the execution module 120 with input parameters of the next generation corresponding to the new genes so as to cause the execution module 120 to further perform trial processes.

When the search using the input parameters is completed, the parameter update module 150 supplies the input parameters obtained, after completion of the search, to the output module 160. For example, when processes for a predetermined number of generations are completed using the genetic algorithm, the parameter update module 150 can supply input parameters corresponding to the genes of a group of individuals which have survived to the output module 160.

The output module 160 outputs the group of input parameters obtained after completion of the search. For example, the output module 160 can display the obtained input parameters on a display, and/or store the input parameters in a storage device such as the database 20.

Thus, the information processing system 10, in accordance with an embodiment of the present invention, not only determines final evaluation values of trial processes corresponding to multiple input parameters, but also determines degrees of similarity obtained from features of the trial processes that can be used to search for a group of optimized input parameters. Therefore, the information processing system 10 maintains diversity in a group of solutions for the final input parameters obtained in accordance with various phenomena occurring in the course of simulations.

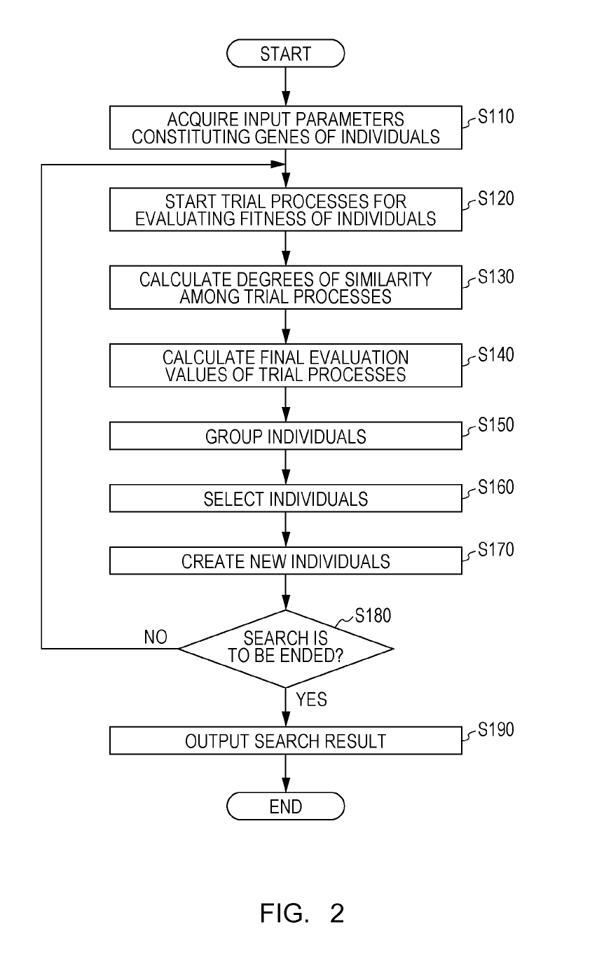

FIG. 2 illustrates a process flow performed by the information processing system 10, in accordance with an embodiment of the present invention. In an embodiment, the information processing system 10 performs the processes flow of S110 to S190 using the genetic algorithm to search for optimized input parameters.

At S110, the acquiring module 110 acquires multiple input parameters, each of which is defined with the gene of a corresponding individual in terms of the genetic algorithm, from the database 20. For example, the acquiring module 110 acquires data including multiple variables, each of which includes one or more bits, as an input parameter. In this case, the acquiring module 110 acquires a bit sequence constituting an input parameter, as the gene of an individual in terms of the genetic algorithm. In addition, the acquiring module 110 may generate a bit sequence having random values, as the gene of an individual in terms of the genetic algorithm. The acquiring module 110 supplies the obtained input parameters to the execution module 120.

At S120, the execution module 120 starts performing a time-series trial process on each of the input parameters which correspond to the gene of a corresponding one of the individuals. For example, the execution module 120 receives multiple variables included in the gene of each of the individuals as an initial condition of a corresponding trial process, and performs the trial process.

In various embodiments, the execution module 120 carries out an agent-based simulation in which the operations/states of multiple agents are simulated at multiple chronological time points, as a trial process. For each of the trial processes which are being performed, the execution module 120 can supply information about the execution state of the trial process, such as the states of the agents, to the evaluation calculating module 130 and the similarity calculating module 140.

The evaluation calculating module 130 can calculate evaluation values at multiple time points for each of the trial processes. For example, the evaluation calculating module 130 calculates objective function values from the agent states at each of the time points in the trial process, and uses the arithmetic mean or the geometric mean of the calculated objective function values as an evaluation value. The evaluation calculating module 130 can use a function that was predefined or predetermined by a user as an objective function, or can use a single objective function instead of using multiple objective functions. The evaluation calculating module 130 can supply the calculated evaluation values to the similarity calculating module 140 and the parameter update module 150.

At S130, the similarity calculating module 140 calculates degrees of similarity among the trial processes on the basis of the feature values extracted from the trial processes, each of which is performed by the execution module 120 on a corresponding one of the input parameters. The similarity calculating module 140 can determine a feature value by using a predefined method or a method predetermined by a user. For example, for each of the trial processes, the similarity calculating module 140 can obtain evaluation values at one or more time points including a halfway time point in the corresponding period, among the evaluation values for the multiple periods, from the evaluation calculating module 130 as feature values.

Alternatively, instead of using evaluation values of a trial process as feature values, the similarity calculating module 140 can extract various types of feature values representing the feature of a trial process, and calculate degrees of similarity among the trial processes. For example, instead of evaluation values in each of the periods, the similarity calculating module 140 extracts objective function values in the period as feature values. In this case, the similarity calculating module 140 can extract multiple feature values from values of multiple objective functions at each time point.

The similarity calculating module 140 may add a greater weight to an evaluation value at a newer time point among the time points, such that the evaluation value at a newer time point becomes larger, and as such can be used as a feature value. For example, the similarity calculating module 140 obtains a value, obtained by multiplying the evaluation value at a new time point by a weighting coefficient which is larger than that at an old time point, as a feature value.

The similarity calculating module 140 can calculate degrees of similarity among trial processes on the basis of closeness of the feature values of the trial processes. For example, for each of the trial processes, the similarity calculating module 140 can use as a feature value each of the values of one or more objective functions at one or more time points, including a halfway time point of the trial process. In various embodiments, the similarity calculating module 140 generates a feature vector for each trial process that includes the feature values as elements, calculates the reciprocal of the distance between the feature vectors for the plurality of trial processes (for example, a Euclidean distance, or a power; a radical root; etc. of the Euclidean distance) to determine the closeness of the feature values, and uses the reciprocal as a degree of similarity.

For example, assume that a trial process has time points n to m where n and m are integers satisfying 1≦n<m≦N in the case where the trial process includes the first to Nth time points (N is an integer equal to or greater than three). The similarity calculating module 140 can generate a feature vector (vₙ, vₙ₊₁, . . . , vₘ) on the basis of an evaluation value vₙ at a time point n and evaluation values vₙ₊₁, . . . , vₘ at the subsequent time points, as the feature vector. In another example, the similarity calculating module 140 generates, as the feature vector, a feature vector (f¹ₙ, f²ₙ, f²ₙ₊₁, . . . , f¹ₘ, f²ₘ) on the basis of a first objective function value f¹ₙ and a second objective function value f²ₙ at a time point n in a trial process, a first objective function value f¹ₙ₊₁ and a second objective function value f²ₙ₊₁ at the next time point, . . . , a first objective function value f¹ₘ and a second objective function value f²ₘ at a time point m.

In various embodiments, instead of using a feature vector, the similarity calculating module 140 can use a time point n which is present between the start time point and the end time point, and can use the reciprocal of the absolute value of the difference between the evaluation value vₙ of a trial process and the evaluation value v′ₙ of another trial process as a degree of similarity between these trial processes.

In other embodiments, the similarity calculating module 140 calculates a degree of similarity on the basis of whether or not an unexpected phenomenon has occurred at a close time point. For example, if a phenomenon (such as the evaluation value and/or the objective functions change in the same direction by a large amount) occurs at the same time point or a close time point in more than one trial process, the similarity calculating module 140 can provide a relatively high degree of similarity for the combination of these trial processes.

The similarity calculating module 140 can calculate a degree of similarity between trial processes for each of the combinations of the multiple trial processes, and can supply the calculated degrees of similarity to the parameter update module 150.

At S140, the evaluation calculating module 130 calculates the final evaluation values of the trial processes. For example, the evaluation calculating module 130 calculates an evaluation value from the multiple objective functions at the end time point in each of the trial processes, as the final evaluation value of the trial process. Alternatively, the evaluation calculating module 130 can calculate the arithmetic mean, the geometric mean, etc. of the evaluation values at multiple time points in each of the trial processes, as the final evaluation value of the trial process.

At S150, the parameter update module 150 groups the multiple individuals on the basis of the degrees of similarity among the trial processes using the input parameters corresponding to the genes. For example, the parameter update module 150 groups the multiple individuals such that input parameters corresponding to the trial processes whose degrees of similarity are equal to or less than a predetermined threshold belong to a group.

At S160, for each of the groups, the parameter update module 150 selects individuals in the group on the basis of the evaluation values of input parameters corresponding to genes. For example, for each of the groups, the parameter update module 150 can cause individuals in the group, whose final evaluation value of the input parameter corresponding to the gene is within the predetermined rank and/or equal to or more than a predetermined threshold, to survive. Parameter update module 150 can delete the other genes. In various embodiments, for each of the groups, the parameter update module 150 causes only the individual having the final evaluation value which is the highest in the group to survive, and selects the others to not survive.

Alternatively, the parameter update module 150 can assign, to each of the individuals having a particular gene, a survival rate which corresponds to the final evaluation value, determine whether or not each of the individuals is to survive in accordance with the probability according to the survival rate, and select individuals which are determined not to survive.

At S170, the parameter update module 150 uses the genes of the individuals which have survived at S160, to create new genes. Parameter update module 150 can create new genes by performing crossover, mutation, and/or self-replication operators on the basis of the predetermined genetic algorithm.

For example, the parameter update module 150 makes a pair by selecting two genes of the individuals which have survived, and selects one or more crossover points randomly on the bit sequence at which the genes are to be recombined, so as to perform a crossover operator on the genes in the pair at the crossover points. For example, for the individuals in the pair, the parameter update module 150 performs the crossover operator by exchanging corresponding variables included in the genes or by calculating the arithmetic mean of the corresponding variables, and creates a new gene for a next-generation individual. The parameter update module 150 can perform the crossover operator by using a set of three or more genes instead of a pair of genes.

In various embodiments, the parameter update module 150 performs a mutation operator by reversing some of values in the bit sequence, included in the gene of an individual which has survived, with a predetermined probability so as to create a new gene for a next-generation individual. In various embodiments, the parameter update module 150 performs a self-replication operator by leaving the gene of an individual which has survived, as it is, behind for the next generation.

At S180, the parameter update module 150 determines whether or not to end the search. The parameter update module 150 can, for example, determine that the search has been performed for a predetermined number of generations; determine that individuals have been generated whose genes supply a final evaluation value which is equal to or greater than a predetermined threshold; and/or determine that a state in which an improvement of the final evaluation value obtained by each of the genes is less than a predetermined threshold has been continued for a predetermined number of generations, and end the trial processes.

If the trial processes are not to be ended, the parameter update module 150 can supply the input parameters corresponding to the newly created genes to the execution module 120, and the process returns to S120. At S120 of the second iteration, and its subsequent iterations, the execution module 120 performs the trial processes again on the input parameters defined by the new genes of the next-generation individuals.

If the trial processes are to be ended, the parameter update module 150 can supply the input parameters to the output module 160, and the process proceeds at S190. For example, the parameter update module 150 supplies all of the input parameters corresponding to the genes of individuals which have survived all process iterations, or supplies some input parameters which have high evaluation values among the input parameters to the output module 160.

At S190, the output module 160 outputs the input parameters obtained after completion of the search. For example, the output module 160 displays the input parameters obtained through the search, on a display. The output module 160 may also display the objective function values and/or the evaluation values obtained by performing the trial processes on the input parameters obtained through the search.

Thus, the information processing system 10, in accordance with an embodiment of the present invention, performs processes from S110 to S190, grouping multiple individuals on the basis of the features at time points in the course of the trial processes. Therefore, diversity of the newly created individuals is more surely ensured.

If individuals are grouped only on the basis of the similarity of the final evaluation values of the trial processes, individuals corresponding to the trial processes satisfying the following conditions can incorrectly be grouped as being similar. The conditions include different phenomena occurring during the course of the trial processes, and totally different objective function values being obtained in the course of the search whose final evaluation values are close to one another by coincidence. The above conditions may result in individuals whose trial processes are substantially not similar to one another being grouped as similar. In such a case, diversity of the newly created individuals can be damaged.

In contrast, the information processing system 10, in accordance with embodiments of the present invention, groups individuals, with a high probability that phenomena occurring in the trial processes are similar to one another, into one group on the basis of the features throughout the course of the trial processes. Therefore, as a result of selection in the groups, diversity of individuals which have survived as typifications of the groups is guaranteed. As a result, the information processing system 10 can also maintain diversity of the newly created individuals. Therefore, the information processing system 10 can provide a decision-maker with candidates of solutions of various input parameters which are present near the Pareto front, and allow a decision-maker to select a final solution in accordance with priority, preference, etc.

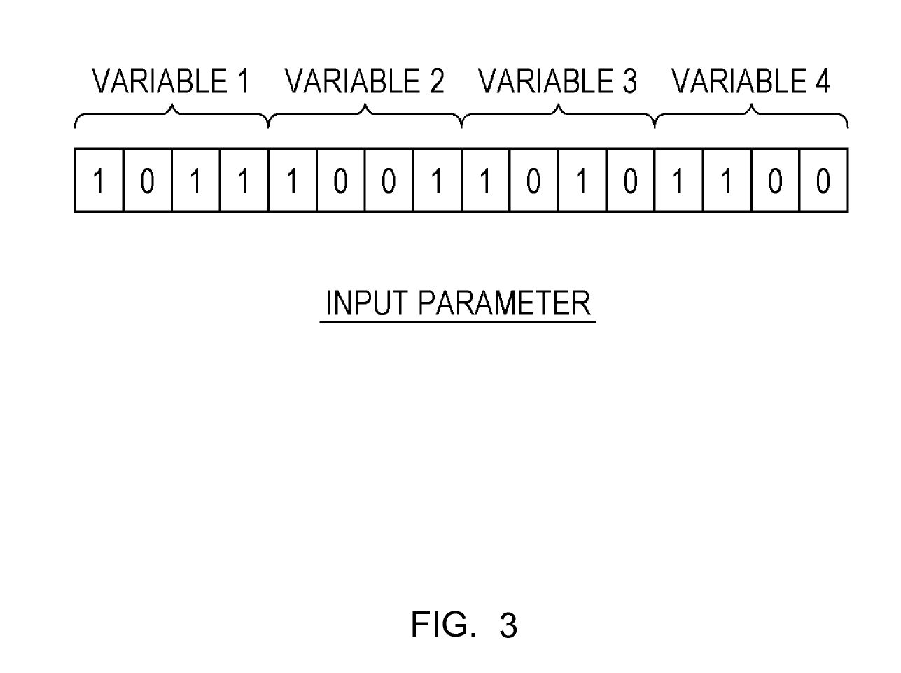

FIG. 3 illustrates an exemplary input parameter to be processed by the information processing system 10, in accordance with an embodiment of the present invention. An input parameter can be used as a gene in the genetic algorithm, and can be constituted by a bit sequence including multiple bits as illustrated in FIG. 3. The bit sequence in an input parameter can be constituted by multiple variables defining an initial condition of the trial process. For example, as illustrated in FIG. 3, an input parameter includes a variable 1 from the first bit to the fourth bit, a variable 2 from the fifth bit to the eighth bit, a variable 3 from the ninth bit to the twelfth bit, and a variable 4 from the thirteenth bit to the sixteenth bit.

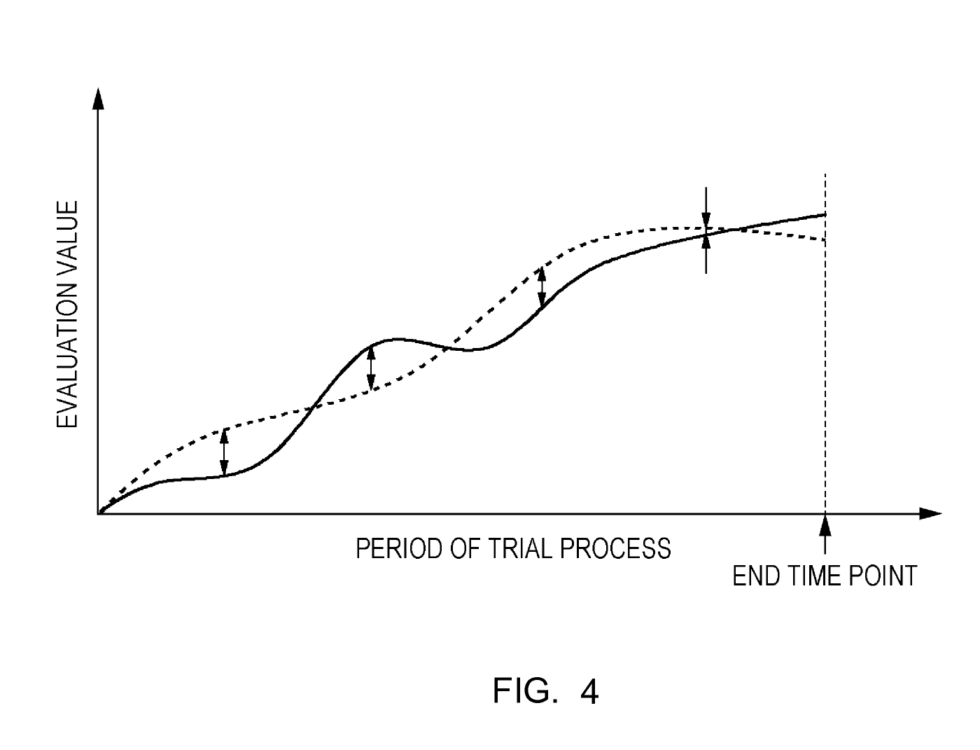

FIG. 4 illustrates an exemplary degree of similarity calculated by the similarity calculating module 140, in accordance with an embodiment of the present invention. The changes in the evaluation values in two trial processes are illustrated by using a solid line and a dotted line. At S130 (FIG. 2), the similarity calculating module 140 uses evaluation values at multiple time points in the trial process as feature values for the trial period (four time points are shown in FIG. 4). As a result, the similarity calculating module 140 calculates a degree of similarity between trial processes among multiple trial processes on the basis of the absolute value of the difference (arrow in FIG. 4) between the evaluation values at each time point.

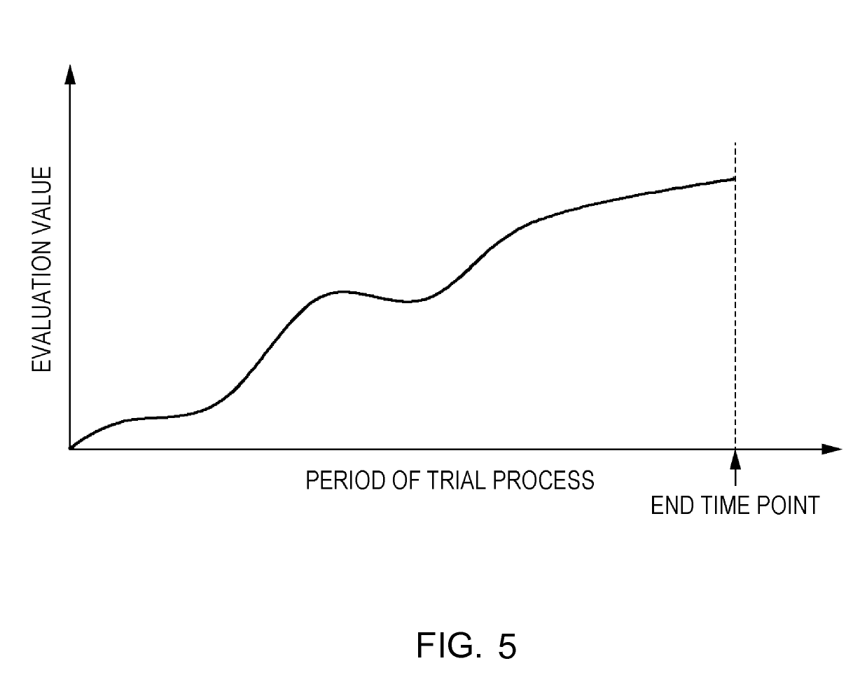

FIG. 5 illustrates exemplary evaluation values calculated by the evaluation calculating module 130, in accordance with an embodiment of the present invention. At S140 (FIG. 2), the evaluation calculating module 130 calculates an evaluation value at the end time point in the trial process as the final evaluation value used for selection of individuals.

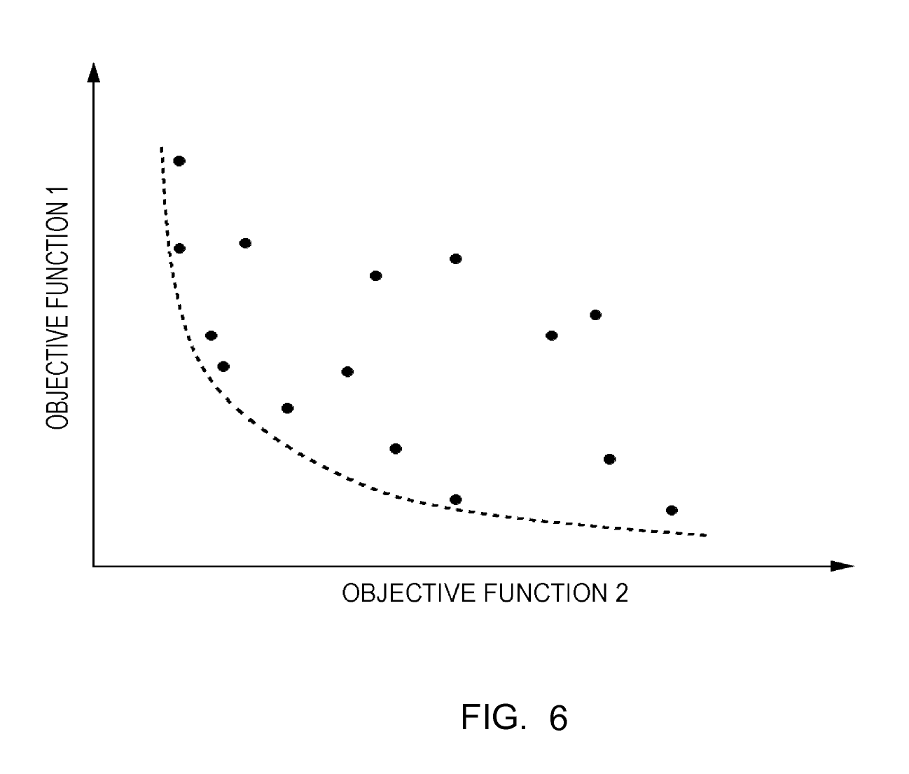

FIG. 6 illustrates an exemplary relationship between multiple individuals and the corresponding objective function values, in accordance with an embodiment of the present invention. The multiple points in FIG. 6 correspond to the respective individuals, and the vertical axis and the horizontal axis of the graph represent an objective function 1 value and an objective function 2 value which are finally obtained in the trial process corresponding to each of the individuals. In this example, the smaller the values of the objective function 1 and the objective function 2 (that is, closer to the origin), the higher the evaluation value of the trial process. In this case, the Pareto front appears near the positions indicated with a dotted line in FIG. 6.

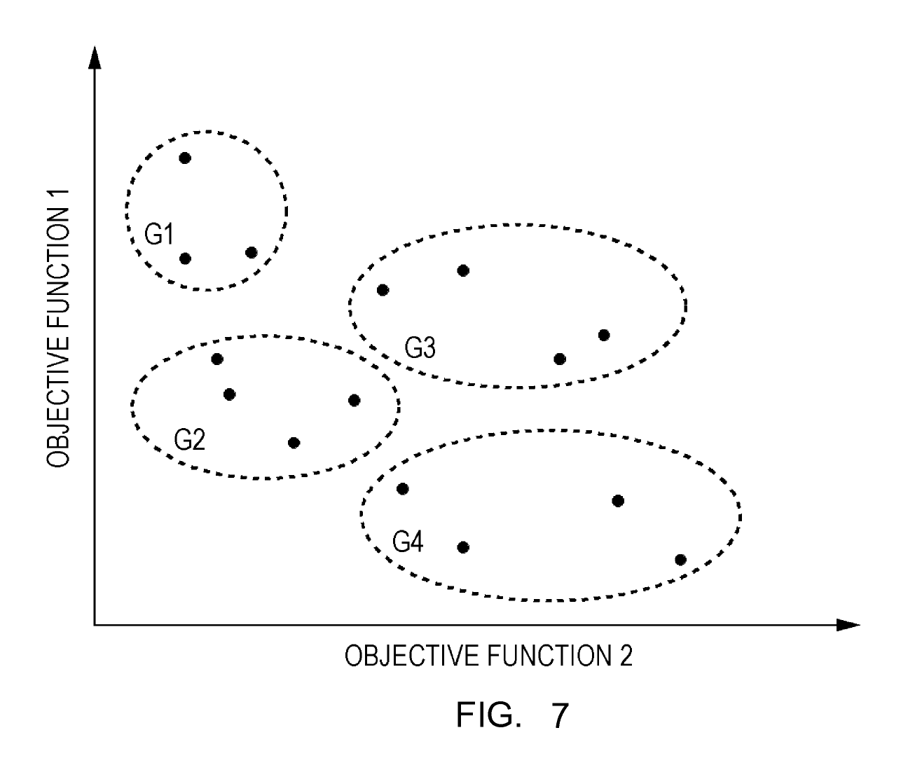

FIG. 7 illustrates exemplary groupings of individuals by the parameter update module 150, in accordance with an embodiment of the present invention. As illustrated in FIG. 7, the parameter update module 150 groups the multiple individuals illustrated in FIG. 6 into four groups G1, G2, G3, G4 in which features of trial processes are similar to one another (that is, the distance between the feature vectors including two objective function values is close).

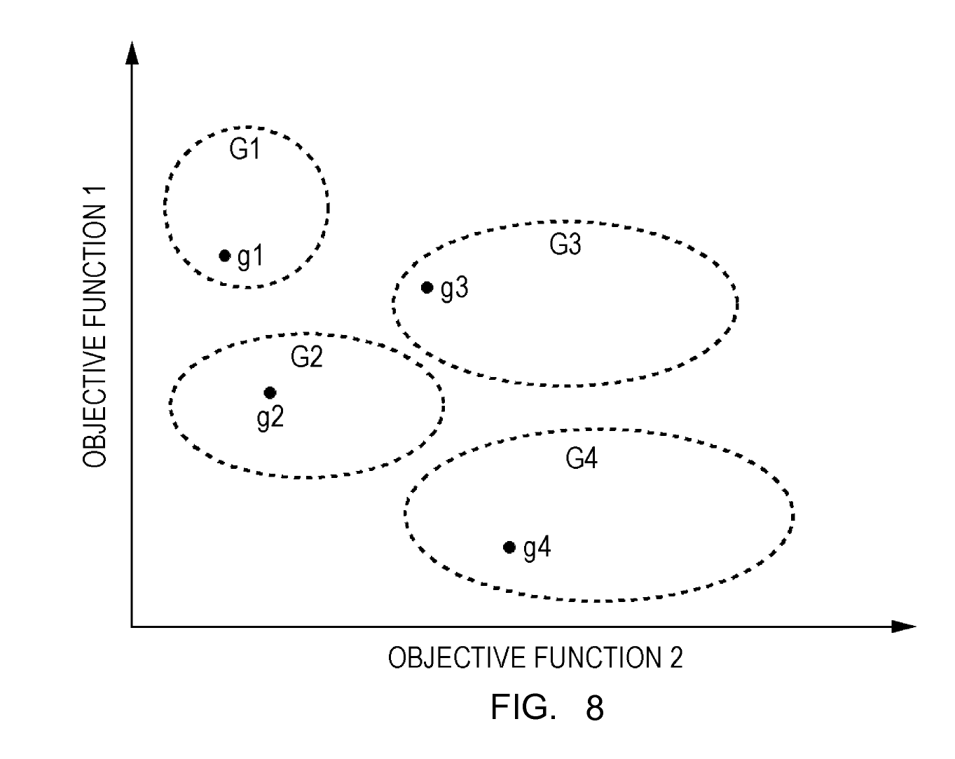

FIG. 8 illustrates exemplary selection of individuals by the parameter update module 150, in accordance with an embodiment of the present invention. As illustrated in FIG. 8, the parameter update module 150 causes one individual g1, g2, g3, g4, having the highest evaluation value among the individuals in their respective group, to survive in each of the groups illustrated in FIG. 7. Parameter update module 150 may delete the other individuals.

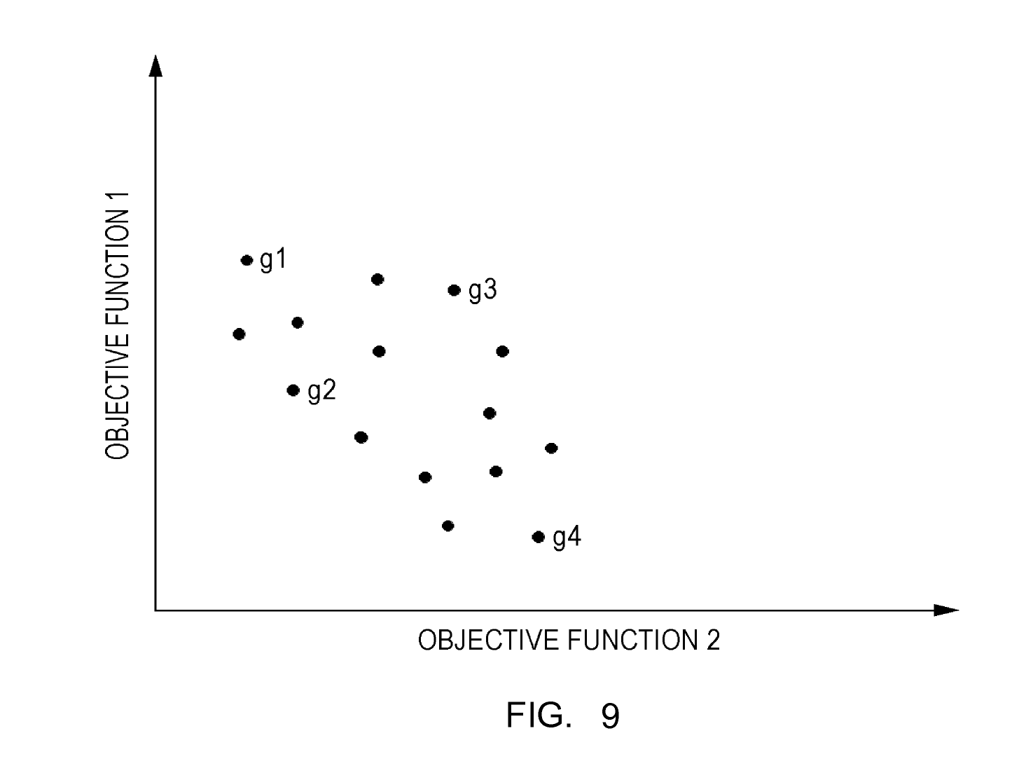

FIG. 9 illustrates exemplary creation of new individuals by the parameter update module 150, in accordance with an embodiment of the present invention. As illustrated in FIG. 9, the parameter update module 150 creates new individuals based on the individuals which have survived in FIG. 8. The parameter update module 150 can perform a crossover operation on the individuals grouped on the basis of the degrees of similarity, enabling new individuals, with genes in which diversity is maintained, to be created.

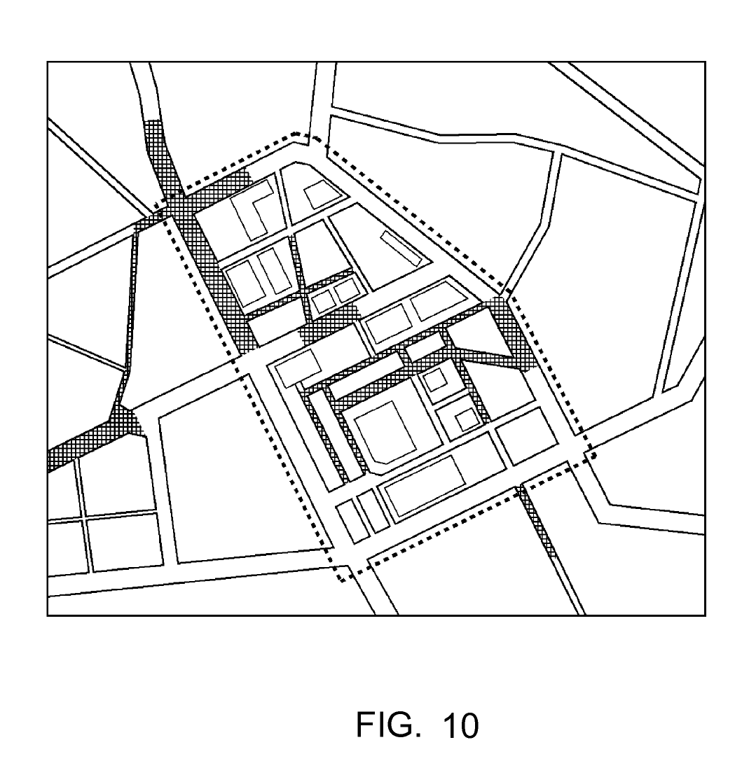

FIG. 10 illustrates an exemplary trial process of the information processing system 10, in accordance with an embodiment of the present invention. The information processing system 10 can perform a traffic simulation as the trial process. For example, the acquiring module 110 can receive information about traffic regulations at multiple locations in a city, as input parameters.

In the above example, the acquiring module 110 receives one of “no traffic control”, “one-way traffic (passing is not allowed in one direction and the amount of traffic in the reverse direction is twice as much as the normal traffic)”, “one-way traffic in the reverse direction (the amount of traffic in one direction is twice as much as the normal traffic and passing is not allowed in the reverse direction)”, and “closed (no passing is allowed in both of the directions)” for each of sixteen roads in the city, as an input parameter. The acquiring module 110 acquires input parameters in which one of the four types of regulations randomly sets to each of the locations of the sixteen roads, from the database 20 as the first-generation genes.

When the execution module 120 performs a simulation of the traffic conditions in which a large number of vehicles are regarded as agents on the basis of the input parameters, traffic jams occur in some parts of roads as illustrated with hatched lines in FIG. 10. The evaluation calculating module 130 may use a first objective function of summing distances of traffic jams occurring in the center area of the city (the area within the dotted line in FIG. 10) and a second objective function of summing distances of traffic jams occurring in the suburban area (the area outside of the dotted line in FIG. 10), and calculate an evaluation value from the arithmetic mean of the first and second objective function values. For example, the evaluation calculating module 130 calculates an evaluation value of the traffic condition every ten minutes from 10 to 60 minutes.

The similarity calculating module 140 can calculate degrees of similarity by using the sum of the traffic jam distances in the center area of the city and the sum of the traffic jam distances in the suburban area as feature values.

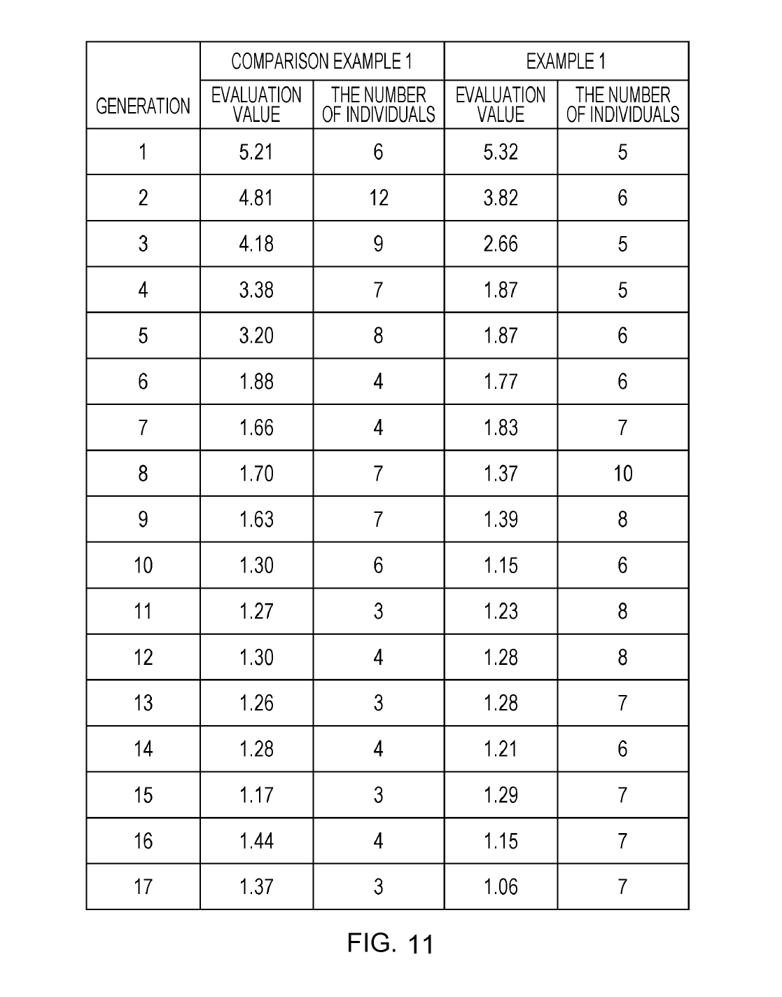

FIG. 11 illustrates exemplary process results of the information processing system 10 and comparison results, in accordance with an embodiment of the present invention. The example 1 shows a result obtained by the information processing system 10 performing the trial process, described in FIG. 10, on multiple individuals and completing the genetic algorithm according to the present embodiment. The comparison example 1 shows a result obtained by performing the gene algorithm in the same condition as that of the example 1 except based on the method described in “Multiobjective Genetic Algorithms”.

The generation in FIG. 11 represents the generation number for which the crossover and selection operators are performed by using the genetic algorithm. The evaluation value represents the average of evaluation values of all of the individuals in each generation (in this example, the smaller the evaluation value, the better the result). The number of individuals represents the number of individuals which are located at positions closest to the Pareto front (rank 1) among all of the individuals in each generation. As illustrated in FIG. 11, compared with the comparison example 1, the example 1 holds more individuals with a rank 1, providing more diversity of individuals. FIG. 11 shows that diversity for example 1, higher than that of the comparison example 1, is maintained. As a result, newly created individuals are not locally optimized, resulting in creation of individuals having evaluation values better than those in the comparison example 1.

In certain embodiments of the present invention, the execution module 120 obtains results of actual tests as the trial processes, instead of performing a simulation. For example, the execution module 120 uses values obtained by performing actual tests such as tests of chemical substances for their effectiveness under the conditions according to input parameters and by measuring the effectiveness at times in the actual tests as objective function values. In various embodiments, the execution module 120 performs a flow simulation using a cellular automaton as a trial process, instead of an agent-based simulation.

In various embodiments, the information processing system 10 optimizes input parameters on the basis of a metaheuristic algorithm other than the genetic algorithm. For example, the information processing system 10 uses a method, such as simulated annealing, particle swarm optimization, or tabu search, to optimize multiple input parameters which are input to the time-series trial processes. The information processing system 10 can calculate degrees of similarity among the trial processes on the basis of the feature values extracted from the trial processes by using the method, and can search for optimal solutions while ensuring diversity of the input parameters by using these degrees of similarity. Thus, the information processing system 10 can obtain a group of solutions having diversity, also by using a metaheuristic algorithm other than the genetic algorithm.

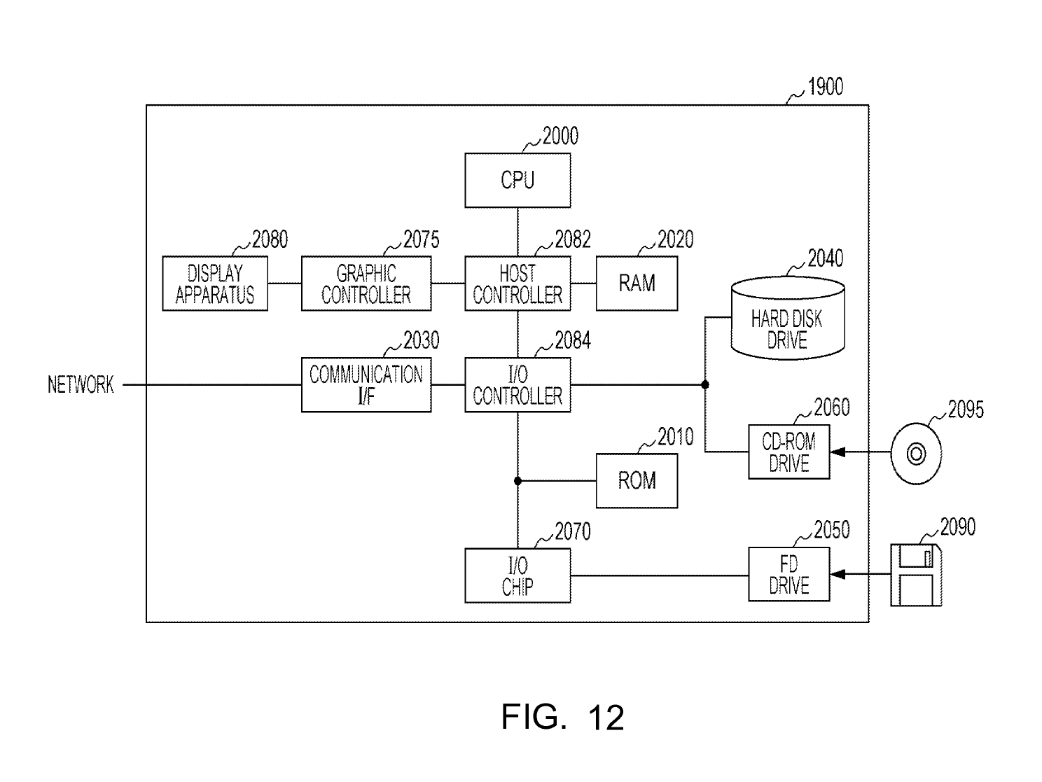

FIG. 12 illustrates an exemplary hardware configuration of a computer 1900 serving as the information processing system 10. The computer 1900 according to the present embodiment includes a CPU peripheral section having a CPU 2000, a RAM 2020, a graphic controller 2075, and a display apparatus 2080 which are connect to each other via a host controller 2082, an input/output section having a communication interface 2030, a hard disk drive 2040, and a CD-ROM drive 2060 which are connected to the host controller 2082 via an input/output controller 2084, and a legacy input/output section having a ROM 2010, a flexible disk drive 2050, and an input/output chip 2070 which are connected to the input/output controller 2084.

The host controller 2082 connects the RAM 2020 to the CPU 2000 and the graphic controller 2075 which access the RAM 2020 at a high transfer rate. The CPU 2000 operates on the basis of programs stored in the ROM 2010 and the RAM 2020, and controls the units. The graphic controller 2075 obtains image data generated by the CPU 2000 or the like on a frame buffer provided in the RAM 2020, and displays it on the display apparatus 2080. Alternatively, the graphic controller 2075 includes a frame buffer storing the image data generated by the CPU 2000 or the like inside the graphic controller 2075.

The input/output controller 2084 connects the host controller 2082 to the communication interface 2030, the hard disk drive 2040, and the CD-ROM drive 2060 which are relatively high-speed input/output devices. The communication interface 2030 communicates with other apparatuses via a network in a wired or wireless manner. The communication interface serves as hardware for communication. The hard disk drive 2040 stores programs and data which are used by the CPU 2000 in the computer 1900. The CD-ROM drive 2060 reads out programs or data from a CD-ROM 2095, and provides the programs or the data for the hard disk drive 2040 via the RAM 2020.

The input/output controller 2084 is connected to the ROM 2010 and relatively low-speed input/output devices, i.e., the flexible disk drive 2050 and the input/output chip 2070. The ROM 2010 stores boot programs executed when the computer 1900 starts, programs depending on the hardware of the computer 1900, and/or the like. The flexible disk drive 2050 reads out programs or data from the flexible disk 2090, and provides the programs or the data for the hard disk drive 2040 via the RAM 2020. The input/output chip 2070 connects the flexible disk drive 2050 to the input/output controller 2084, and connects various input/output devices to the input/output controller 2084 via a parallel port, a serial port, a keyboard port, a mouse port, and the like.

The programs provided for the hard disk drive 2040 via the RAM 2020 are stored in a recording medium, such as a flexible disk 2090, the CD-ROM 2095, or an IC card, and are provided for a user. The programs are read out from the recording medium, are installed in the hard disk drive 2040 in the computer 1900 via the RAM 2020, and are executed by the CPU 2000.

The programs which are installed in the computer 1900 and which cause the computer 1900 to function as the information processing system 10 include an acquiring module 110, an execution module 120, an evaluation calculating module 130, a similarity calculating module 140, a parameter update module 150, and an output module 160.

By reading out programs to the computer 1900, information processing described in the programs functions as specific means in which software and various hardware resources described above cooperate with each other, i.e., the acquiring module 110, the execution module 120, the evaluation calculating module 130, the similarity calculating module 140, the parameter update module 150, and the output module 160. The specific means achieves calculation or processing of information according to the usage of the computer 1900 according to the present embodiment, whereby an information processing system 10 according to the usage is constructed.

For example, when the computer 1900 communicates with external apparatuses, the CPU 2000 executes communication programs loaded on the RAM 2020, and instructs the communication interface 2030 to perform communication on the basis of processes described in the communication program. Under control of the CPU 2000, the communication interface 2030 reads out transmission data stored in a transmission buffer or the like provided on a storage, such as the RAM 2020, the hard disk drive 2040, the flexible disk 2090, or the CD-ROM 2095, to transmit it to a network, or writes data received from a network on a reception buffer or the like provided on a storage. Thus, the communication interface 2030 can transfer received/transmitted data from/to a storage by using direct memory access (DMA). Alternatively, the CPU 2000 can read out data from a storage or the communication interface 2030 which is a transfer source, and write the data in the communication interface 2030 or a storage which is a transfer destination so that the received/transmitted data is transferred.

The CPU 2000 causes all or a necessary part of a file, a database, or the like stored in an external storage, such as the hard disk drive 2040, the CD-ROM drive 2060 (CD-ROM 2095), or the flexible disk drive 2050 (flexible disk 2090), to be written to the RAM 2020 through DMA transfer or the like, and performs various processes on data on the RAM 2020. The CPU 2000 writes the data which has been processed, back to the external apparatus through DMA transfer or the like. In such a process, the RAM 2020 may be regarded as a storage which temporarily holds data from an external apparatus. Accordingly, in the present embodiment, the RAM 2020, an external storage, and the like are collectively called a memory, a storage unit, a storage, or the like. For example, a storage unit of the information processing system 10 can store data to be received/supplied from/to the acquiring module 110, the execution module 120, the evaluation calculating module 130, the similarity calculating module 140, the parameter update module 150, and/or the output module 160, as appropriate. For example, the storage unit receives genes created by the parameter update module 150, and stores them.

Various types of information, such as various programs, data, tables, and databases, in the present embodiment are stored on such a storage, and are targets of information processing. The CPU 2000 may hold some pieces of the information in the RAM 2020, on a cache memory, and may read and write the information on the cache memory. In such a configuration, the cache memory functions as a part of the RAM 2020. Accordingly, in the present embodiment, except for being distinguished, a cache memory is also included in the RAM 2020, a memory, and/or a storage.

On data which is read out from the RAM 2020, the CPU 2000 performs various processes that include various calculations, information processing, conditional determination, and searching/replacing of information which are described in the present embodiment, and that are specified by using an instruction sequence in programs, and writes the data back to the RAM 2020. For example, when conditional determination is performed, the CPU 2000 compares various variables described in the present embodiment with other variables or constants, and determines whether or not a condition, such as, “larger than”, “smaller than”, “equal to or larger than”, “equal to or smaller than”, or “equal to”, is satisfied. If a condition is satisfied (or is not satisfied), the process branches to a different instruction sequence, or calls a subroutine.

The CPU 2000 searches for information stored in the files, the databases, or the like in a storage. For example, in the case where multiple entries in which the value of a first attribute and the value of a second attribute are associated with each other are stored in a storage, the CPU 2000 searches for an entry matching a condition specifying the value of the first attribute among the multiple entries stored in the storage, and reads out the value of the second attribute stored in the entry. Accordingly, the value of the second attribute corresponding to the first attribute satisfying a predetermined condition can be obtained.

As described above, the present invention is described by using the embodiment. However, the technical scope of the present invention is not limited to the range described in the embodiment. It is clear to a person skilled in the art that various changes or improvements may be made to the above-described embodiment. It is clear that an embodiment to which such changes or improvements are made is also included in the technical scope of the present invention, from the description of the scope of claims.

In the execution order of the processes, such as operations, procedures, steps, stages, and the like in the apparatuses, the systems, the programs, and the methods which are described in the scope of claims, the specification, and the drawings, “before”, “prior to”, or the like is not particularly indicated. In addition, as long as an output of the previous process is not used in the subsequent process, it should be noted that the processes may be performed in any order. Even when operation flows in the scope of claims, the specification, and the drawings are described by using “first”, “next”, and the like for the sake of convenience, it does not mean that it is necessary to perform the processes in this order.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although preferred embodiments have been depicted and described in detail herein, it will be apparent to those skilled in the relevant art that various modifications, additions, substitutions and the like can be made without departing from the spirit of the invention, and these are, therefore, considered to be within the scope of the invention, as defined in the following claims.

What is claimed is:

1. A method for performing a search that optimizes a plurality of input parameters, each of the plurality of input parameters being input to a time-series trial process, the method comprising:
receiving, by a computer, a plurality of input parameters;
performing, by the computer, a trial process on each of the plurality of input parameters;
calculating, by the computer, an evaluation value of the trial process performed on each of the plurality of input parameters;
calculating, by the computer, a degree of similarity among a plurality of trial processes based on a feature value extracted from the trial process performed on a corresponding one of the plurality of input parameters; and
updating, by the computer, the plurality of input parameters based on the evaluation value calculated for each of the plurality of input parameters and the degree of similarity among the plurality of trial processes.

2. The method according to claim 1, wherein the feature value extracted from the trial process performed on a corresponding one of the plurality of input parameters includes an evaluation value at a time point within the time-series trial process.

3. The method according to claim 1, wherein the feature value extracted from the trial process performed on a corresponding one of the plurality of input parameters includes a plurality of evaluation values at a plurality of time points within the time-series trial process.

4. The method according to claim 3, wherein calculating, by the computer, a degree of similarity further comprises:
assigning, by the computer, a priority weight to an evaluation value at a newer time point among the plurality of time points within the time-series trial process; and
including, by the computer, the weighted evaluation value in the feature value.

5. The method according to claim 1, wherein performing, by the computer, a trial process on each of the plurality of input parameters further comprises:
executing, by the computer, at least one objective function on the plurality of input parameters for each of the plurality of trial processes;
calculating, by the computer, a value for the at least one objective function executed on the plurality of input parameters for each of the plurality of trial processes; and
wherein, calculating, by the computer, the evaluation value of the trial process performed on each of the plurality of input parameters further comprises:
calculating, by the computer; the evaluation value based on the calculated value for the at least one objective function executed on the plurality of input parameters.

6. The method according to claim 1,
wherein each of the plurality of input parameters is a gene of a corresponding one of a plurality of individuals,
wherein updating, by the computer, the plurality of input parameters further comprises:
selecting, by the computer, at least two individuals from the plurality of individuals based on the evaluation value of the trial process performed on each of the plurality of input parameters; and
performing, by the computer, a crossover operator on the at least two selected individuals to create a new individual; and
wherein performing, by the computer, the trial process, the trial process is performed on an input parameter that is a gene of the new individual.

7. The method according to claim 6, wherein updating, by the computer, the plurality of input parameters further comprises:
grouping, by the computer, the plurality of individuals based on the calculated degree of similarity among the plurality of trial processes for the input parameters corresponding to the plurality of individuals; and
wherein selecting, by the computer, at least two individuals from the plurality of individuals further comprises:
selecting, by the computer, at least two individuals from each group based on the evaluation value of the trial process performed on each of the plurality of input parameters for the individuals in the group.

8. The method according to claim 1, wherein the trial process is an agent-based simulation.

9. A computer program product for performing a search that optimizes a plurality of input parameters, each of the plurality of input parameters being input to a time-series trial process, the computer program product comprising one or more computer readable storage medium and program instructions stored on at least one of the one or more computer readable storage medium, the program instructions comprising:
program instructions to receive, by a computer, a plurality of input parameters;
program instruction to perform, by the computer, a trial process on each of the plurality of input parameters;
program instructions to calculate, by the computer, an evaluation value of the trial process performed on each of the plurality of input parameters;
program instructions to calculate, by the computer, a degree of similarity among a plurality of trial processes based on a feature value extracted from the trial process performed on a corresponding one of the plurality of input parameters; and
program instructions to update, by the computer, the plurality of input parameters based on the evaluation value calculated for each of the plurality of input parameters and the degree of similarity among the plurality of trial processes.

10. The computer program product according to claim 9, wherein the feature value extracted from the trial process performed on a corresponding one of the plurality of input parameters includes an evaluation value at a time point within the time-series trial process.

11. The computer program product according to claim 9, wherein the feature value extracted from the trial process performed on a corresponding one of the plurality of input parameters includes a plurality of evaluation values at a plurality of time points within the time-series trial process.

12. The computer program product according to claim 11, wherein program instructions to calculate, by the computer, a degree of similarity further comprises:
program instructions to assign, by the computer, a priority weight to an evaluation value at a newer time point among the plurality of time points within the time-series trial process; and
program instruction to include, by the computer, the weighted evaluation value in the feature value.

13. The computer program product according to claim 9, wherein program instruction to perform, by the computer, a trial process on each of the plurality of input parameters further comprises:
program instructions to execute, by the computer, at least one objective function on the plurality of input parameters for each of the plurality of trial processes;
program instructions to calculate, by the computer, a value for the at least one objective function executed on the plurality of input parameters for each of the plurality of trial processes; and
wherein, program instructions to calculate, by the computer, the evaluation value of the trial process performed on each of the plurality of input parameters further comprises:
program instructions to calculate, by the computer; the evaluation value based on the calculated value for the at least one objective function executed on the plurality of input parameters.

14. The computer program product according to claim 9,
wherein each of the plurality of input parameters is a gene of a corresponding one of a plurality of individuals,
wherein program instructions to update, by the computer, the plurality of input parameters further comprises:
program instructions to select, by the computer, at least two individuals from the plurality of individuals based on the evaluation value of the trial process performed on each of the plurality of input parameters; and
program instructions to perform, by the computer, a crossover operator on the at least two selected individuals to create a new individual; and
wherein program instructions to perform, by the computer, the trial process, the trial process is performed on an input parameter that is a gene of the new individual.

15. The computer program product according to claim 14, wherein program instructions to update, by the computer, the plurality of input parameters further comprises:
program instructions to group, by the computer, the plurality of individuals based on the calculated degree of similarity among the plurality of trial processes for the input parameters corresponding to the plurality of individuals; and
wherein program instructions to select, by the computer, at least two individuals from the plurality of individuals further comprises:
program instructions to select, by the computer, at least two individuals from each group based on the evaluation value of the trial process performed on each of the plurality of input parameters for the individuals in the group.

16. The computer program product according to claim 9, wherein the trial process is an agent-based simulation.

17. A computer system for performing a search that optimizes a plurality of input parameters, each of the plurality of input parameters being input to a time-series trial process, the computer system comprising one or more processors, one or more computer readable memories, one or more computer readable tangible storage medium, and program instructions stored on at least one of the one or more storage medium for execution by at least one of the one or more processors via at least one of the one or more memories, the program instructions comprising:
program instructions to receive, by a computer, a plurality of input parameters;
program instruction to perform, by the computer, a trial process on each of the plurality of input parameters;
program instructions to calculate, by the computer, an evaluation value of the trial process performed on each of the plurality of input parameters;
program instructions to calculate, by the computer, a degree of similarity among a plurality of trial processes based on a feature value extracted from the trial process performed on a corresponding one of the plurality of input parameters; and
program instructions to update, by the computer, the plurality of input parameters based on the evaluation value calculated for each of the plurality of input parameters and the degree of similarity among the plurality of trial processes.

18. The computer system according to claim 17, wherein program instruction to perform, by the computer, a trial process on each of the plurality of input parameters further comprises:
program instructions to execute, by the computer, at least one objective function on the plurality of input parameters for each of the plurality of trial processes;
program instructions to calculate, by the computer, a value for the at least one objective function executed on the plurality of input parameters for each of the plurality of trial processes; and
wherein, program instructions to calculate, by the computer, the evaluation value of the trial process performed on each of the plurality of input parameters further comprises:
program instructions to calculate, by the computer; the evaluation value based on the calculated value for the at least one objective function executed on the plurality of input parameters.

19. The computer system according to claim 17,
wherein each of the plurality of input parameters is a gene of a corresponding one of a plurality of individuals,
wherein program instructions to update, by the computer, the plurality of input parameters further comprises:
program instructions to select, by the computer, at least two individuals from the plurality of individuals based on the evaluation value of the trial process performed on each of the plurality of input parameters; and
program instructions to perform, by the computer, a crossover operator on the at least two selected individuals to create a new individual; and
wherein program instructions to perform, by the computer, the trial process, the trial process is performed on an input parameter that is a gene of the new individual.

20. The computer system according to claim 19, wherein program instructions to update, by the computer, the plurality of input parameters further comprises:
program instructions to group, by the computer, the plurality of individuals based on the calculated degree of similarity among the plurality of trial processes for the input parameters corresponding to the plurality of individuals; and
wherein program instructions to select, by the computer, at least two individuals from the plurality of individuals further comprises:
program instructions to select, by the computer, at least two individuals from each group based on the evaluation value of the trial process performed on each of the plurality of input parameters for the individuals in the group.
